(19) United States
(12) Patent Application Publication
(10) Pub. No.: US 2013/0086575 A1
(43) Pub. Date: Apr. 4, 2013

(54) APPLICATION BURNING DEVICE FOR POWER PWM CONTROLLERS AND APPLICATION BURNING METHOD

(71) Applicants: Fang-Ta TAI, Tu-Cheng (TW); Jen-Fan SUN, Tu-Cheng (TW); Chen-Hsiang LIN, Tu-Cheng (TW); Cheng-I LIN, Tu-Cheng (TW)

(72) Inventors: Fang-Ta TAI, Tu-Cheng (TW); Jen-Fan SUN, Tu-Cheng (TW); Chen-Hsiang LIN, Tu-Cheng (TW); Cheng-I LIN, Tu-Cheng (TW)

(73) Assignee: HON HAI PRECISION INDUSTRY CO., LTD., Tu-Cheng (TW)

(21) Appl. No.: 13/303,164

(22) Filed: Nov. 23, 2011

(30) Foreign Application Priority Data
Sep. 29, 2011 (TW) 100135161

(51) Int. Cl. G06F 9/445

(52) U.S. Cl. 717/174

(57) ABSTRACT

An application burning device and at least one power PWM controller are mounted on a main board. The device includes a processor and a storage unit storing applications to be burned to the at least one power PWM controller. The processor determines whether there is a power PWM controller not burned yet, and burns a corresponding application to the controller. A related application burning method is also provided.

### BACKGROUND

1. Technical Field

The present disclosure relates to an application burning device capable of burning applications into power PWM controllers and an application burning method.

2. Description of Related Art

Commonly, there are two ways to burn applications to power PWM (Pulse Width Modulation) controllers to be mounted on a main board. The first way is burning the applications into the controllers, and then mounting the power PWM controllers on the main board after testing. The second way is mounting the power PWM controllers on the main board, and then burning the applications into the PWM controllers through an ICT (In-Circuit-Test) machine. With the first way, it is difficult to distinguish which controllers have been done and which have not. With the second way, using of the ICT machine increases the production cost of the main board.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of a main board mounted with a plurality of power PWM controllers and an application burning device in accordance with an exemplary embodiment.

FIG. 2 is a flowchart of an application burning method to burn an application into one of the power PWM controllers of FIG. 1 in accordance with an exemplary embodiment.

### DETAILED DESCRIPTION

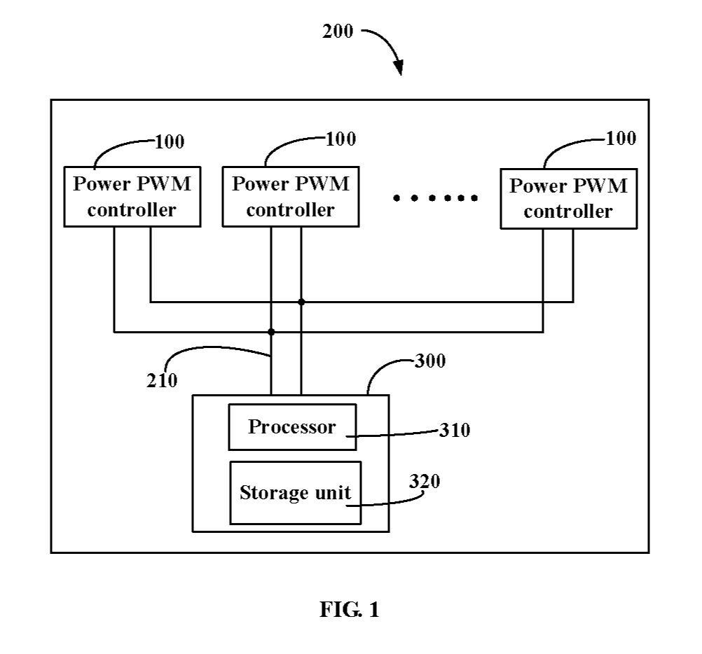

Referring to FIG. 1, at least one power PWM controller 100 is mounted on a main board 200. Each controller 100 supplies appropriate power to at least one electronic component, such as a processing chip, on the main board 200. The controllers 100 are classified into a number of types according to power supplied by the controllers 100. Each type of the controllers 100 should be burned with a corresponding application, to ensure proper power is supplied to the corresponding electronic components. A burning device 300 is mounted on the main board 200. In this embodiment, the burning device 300 is a controller embedded on the main board 200. The embedded controller 300 is electrically connected to each controller 100 through an Inter-Integrated Circuit Bus 210. The embedded controller 300 includes a processor 310 and a storage unit 320. The storage unit 320 stores applications needed by the different types of controllers 100.

The processor 310 determines whether there is a controller 100 not burned yet. In this embodiment, each controller 100 provides an indication to indicate whether an application has been burned into the controller 100 yet. For example, the indicator could be a logic one signal indicating that the application has been burned into the controller 100, and a logic zero signal indicating that the application has not been burned into the controller 100 yet. In this way, the processor 310 can determine which, if any, controllers 100 have not been burned yet.

The processor 310 then burns the corresponding application into any controllers 100 not burned yet. In this embodiment, before burning a controller 100, the processor 310 determines the type of controller 100, obtains the corresponding application of the controller 100 accordingly, and then burns the obtained application into the controller 100. Each controller 100 is assigned with a type code, and the processor 300 determines the type of the controller 100 according to the type code of the controller 100.

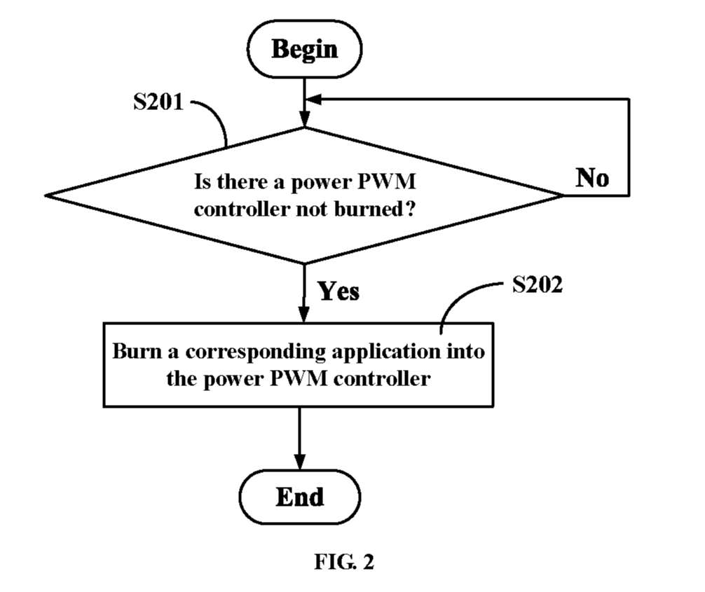

Referring to FIG. 2, a flowchart of an application burning method to burn an application into one of the power PWM controllers amounted on the main board is shown.

In step S201, the processor 310 determines whether there is a power PWM controller 100 not burned yet. If there is a power PWM controller 100 not burned yet, the procedure goes to step S202, otherwise, the procedure returns to step S201. In this embodiment, in step S201, the processor 310 determines which, if any, controllers 100 have not been burned yet according to the application burning indications of the controllers 100.

In step S202, the processor 310 burns the corresponding application into any controllers 100 not burned yet. In this embodiment, in step S202, before burning a controller 100, the processor 310 determines the type of the controller 100, obtains the corresponding application of the controller 100 accordingly, and then burns the obtained application into the controller 100. Each controller 100 is assigned with a type code, and the processor 300 determines the type of the controller 100 according to the type code of the controller 100.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An application burning device for power PWM controllers, the application burning device being mounted on a main board, at least one power PWM controller being mounted on the main board, the application burning device comprising:
a storage unit storing at least one application to be burned to the at least one power PWM controller; and
a processor to
determine whether any of the at least one power PWM controller is not burned; and
burn a corresponding one of the at least one application stored in the storage unit into one of the at least one power PWM controller which is determined by the processor as not burned.

2. The application burning device as described in claim 1, wherein the processor determines whether a power PWM controller is not burned according to an application burning indication of the power PWM controller.

3. The application burning device as described in claim 1, wherein the processor determines the type of the power PWM controller which is not burned, obtains the corresponding application stored in the storage unit according to the determined type.

4. The application burning device as described in claim 3, wherein each of the at least one power PWM controllers is assigned with a type code, and the processor reads the type code to determine the type of a power PWM controller.

5. The application burning device as described in claim 1, wherein the application burning device is a controller embedded on the main board, and the at least one power PWM controller is electrically connected to the embedded controller through an Inter-Integrated Bus.

6. An application burning method applied in an application burning device, the application burning device being mounted on a main board, at least one power PWM controller being mounted on the main board, the application burning device comprising a storage unit and a processor, the storage unit storing at least one application to be burned to the at least one power PWM controller, the application burning method comprising:
determining whether any of the at least one power PWM controller is not burned; and
burning a corresponding one of the at least one application into the one of the at least one power PWM controller which is determined as not burned.

7. The application burning method as described in claim 6, wherein the determining step comprises determining whether a power PWM controller is not burned according to an application burning indication of the power PWM controller.

8. The application burning method as described in claim 6, wherein the processor determines the type of the power PWM controller which is not burned, obtains the corresponding application stored in the storage unit according to the determined type.

9. The application burning method as described in claim 8, wherein each of the at least one power PWM controllers is assigned with a type code, and the processor reads the type code to determine the type of a power PWM controller.
